(19) United States
(12) Patent Application Publication
(10) Pub. No.: US 2024/0349882 A1
(43) Pub. Date: Oct. 24, 2024

(54) FILAMENT BRACING AND MANIPULATING APPARATUS, SYSTEMS, AND METHODS

(71) Applicant: LEXUR LIMITED, Christchurch (NZ)

(72) Inventor: Felix Wells, Christchurch (NZ)

(21) Appl. No.: 18/683,256

(22) PCT Filed: Aug. 14, 2022
(86) PCT No.: PCT/NZ2022/050104

§ 371 Date: Feb. 16, 2024

(30) Foreign Application Priority Data
Aug. 16, 2021 (NZ) 779131

(51) Int. Cl. A46B 17/06; B08B 5/00; B08B 7/00; B08B 7/02; F26B 9/00

(52) U.S. Cl. CPC A46B 17/065; B08B 5/00; B08B 7/0071; B08B 7/02; F26B 9/003

(57) ABSTRACT

The present invention relates to apparatus, methods, and systems used in the bracing and manipulating of filaments. In some embodiments the filaments may refer to filaments of a brush (E.g. bristles). In such embodiments the apparatus, methods, and systems may be used to remove substances (E.g. water) from brush filaments.

### FIELD OF INVENTION

The present invention relates to apparatus, methods, and systems used in the bracing and manipulating of filaments. In particular the invention relates to the drying of brush bristles.

### BACKGROUND OF THE INVENTION

Brushes and other such implements are commonly used to apply various substances such as paints, coatings, or cosmetic products. It is a common desire to clean brushes before reuse. Cleaning of brushes may be for removal of substances which may foul the brush or for sanitary reasons.

### SUMMARY OF THE INVENTION

According to one aspect, the invention is an apparatus comprising a plurality of elements.

According to another aspect the apparatus of the present invention may be used to remove substances (E.g. water or particulates) from filaments (E.g. filaments of a brush).

The apparatus, systems, and methods of the present invention provide an efficient means of removing substance from filaments, in a manner which reduces adverse effects to the filaments and the implements they may be part of. The invention provides advantageous means for controlling the removal of substances including the flexibility to suit a wide range of applications.

These and other aspects, embodiments, and examples of the present disclosure will be understood and appreciated by those skilled in the art upon studying this document.

### BRIEF DESCRIPTION OF THE DRAWINGS

The following are some embodiments of the present invention which are detailed in reference to the drawings, in which:

FIGS. 1 and 2 show some embodiments in axonometric views;

FIG. 3 shows an embodiment in an elevation view;

FIGS. 4 to 9 show some embodiments in axonometric views;

FIGS. 10 to 12 show some embodiments in sectional axonometric views;

FIGS. 13 to 29 show some embodiments in axonometric views;

### DESCRIPTION OF THE INVENTION

The following examples and embodiments are by way of example only.

It will be understood that the understanding of embodiments making use of terms in plural form will also mean to include, but may not expressly state, the same embodiment as would be understood using terms in singular form. Similarly embodiments making use of terms in singular form will also mean to include, but may not expressly state, the same embodiment as would be understood using terms in plural form.

It will also be understood that the understanding of embodiments making use of cumulative conjunctions will also mean to include, but may not expressly state, the same embodiment as would be understood using alternative conjunctions. Similarly it will be understood that the understanding of embodiments making use of alternative conjunctions will also mean to include, but may not expressly state, the same embodiment as would be understood using cumulative conjunctions.

It will further be understood that lists of options or alternatives will also mean to include the various combinations of each item where appropriate. List of options or alternatives are by way of example only and may include but are not limited to such. Where references to items in a list may also include combinations of such items it will also mean to include combinations with related items not listed and the combinations of unlisted items.

In some embodiments affect may be used to describe how the apparatus and/or the elements may affect filaments.

In one embodiment the invention is an apparatus comprising a plurality of elements.

In some embodiments the invention is an apparatus comprising bracing and/or manipulating elements.

In some embodiments the apparatus may be used for: drying filaments; removing substance from filaments; collecting substances from filaments; bracing filaments; manipulating filaments; applying substances to filaments; conditioning filaments.

In some embodiments the elements of the apparatus may ‘brace’ and/or ‘manipulate’ filaments; consequently the apparatus may be referred to as a ‘bracing apparatus’ and/or ‘manipulating apparatus’.

‘Brace’ and ‘bracing’ may include: restrict; limit; inhibit; immobilise; confine; retain; enclose; support; guide; reinforce.

‘Manipulate’ and ‘manipulating’ may include: controlling; modulating; governing; guiding; stabilising; displacing; agitating; rotating; oscillating; heating; cooling; drying; cleaning; sterilising; ventilating; manoeuvring.

It will be understood that ‘elements’ and ‘filaments’ may generally refer to two distinctly different constituents unless otherwise stated. ‘Elements’ may refer to components of an apparatus of the invention, whereas ‘filaments’ may refer to a constituent part of an item that may be contacted to the apparatus of the invention.

The apparatus of the invention may have ‘components’. Components may include: ‘elements’; ‘heating means’; ‘fluid movement means’; ‘desiccating means’; ‘mechanical movement means’; ‘housings’; ‘input means’; ‘output means’; ‘vacuum means’.

Elements may comprise: ‘materials’; ‘forms’; ‘structures’; ‘features’; ‘compositions’; ‘arrangements’; ‘connections’.

Elements may have ‘functions’ or ‘element functions’ which may refer to functions that elements may have when exposed to certain conditions which may not be conductively coupled to the elements including: electrical fields; magnetic field; ambient humidity; ambient temperature; sound waves. Examples of such may include: the heating of elements by induction; electric fields causing vibrations in electrostrictive elements; magnetic fields causing elements to grasp together. Other functions may include: vibrate; oscillate; rotate; clamp; expand; contract; detach; configure; collapse; buckle.

Elements may be capable of performing actions or movements: individually; in combination with; in unison with; as a whole; and may be caused by or controlled by other components. Actions or movements may include: vibrate; oscillate; rotate; clamp; expand; contract; detach; configure; collapse; buckle.

‘Materials’ may refer to the materials of which the elements are made of including: metals; polymers; ceramics; amorphous; crystalline; natural; synthetic.

Materials may have ‘material functions’ wherein the materials may have a particular function. Material functions may include: thermally conductive; thermally insulating; electrically conductive; electrically insulating; hygroscopic; hydrophilic; hydrophobic; wicking; electrostatic; magnetic; electromagnetic; antimicrobial; deodorising; oxidising; soluble; deformable; elastic; specified coefficients of friction; resonant; tunable.

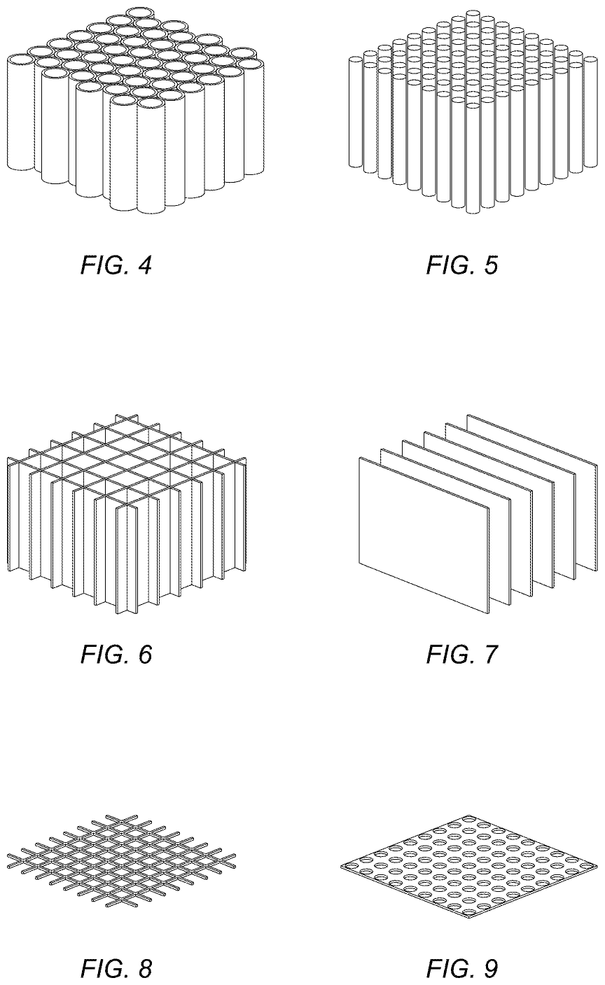

‘Form’ may refer to terms to describe the overall shape or design of elements. Forms may include: grate; grate-like; nets; honeycomb-like; weaves; webs; grills; porous plates; vanes; plates; walls; needles; tubes; cylinders; rods; filaments; fibres; pins. Some illustrative examples may be seen in FIGS. 4-9, 14-17. Elements may be of various shapes and sizes and may also be assortments of various shapes and sizes.

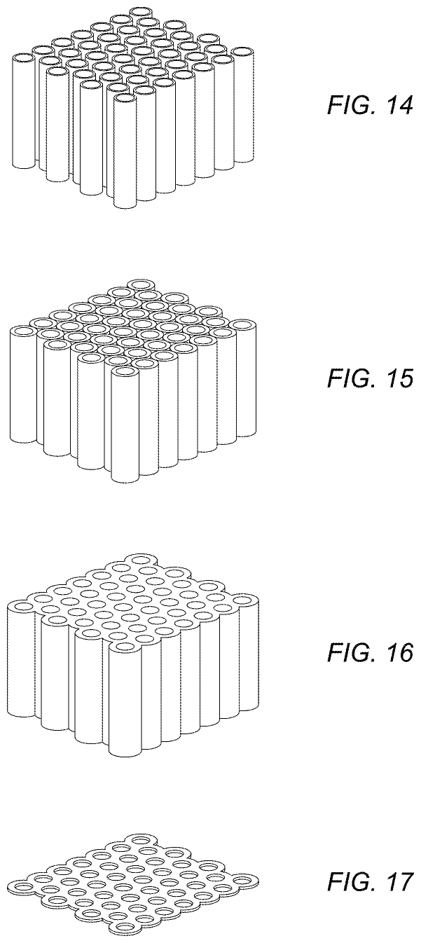

It will be understood that elements may refer to forms being: grate-like; honeycomb-like; prong-like; cylinder-like. In such embodiments the plurality of such elements refers to a plurality of the functional geometric features. For example, a plurality of elements being thin walled cylinders may be arranged such that they do not connect with one another (FIG. 14). An increase in wall thickness of the same cylinders may be such that they form a connection (FIG. 15). A further increase in wall thickness of the same cylinders may resemble a honeycomb (FIG. 16). A change in the length of the cylinders may resemble a grate (FIG. 17). Wherein each example may share similar functional features which are present in a plurality (E.g. the internal diameter of the cylinders), and may differ in the way they are connected, such that FIG. 16 may be both a plurality of elements being cylinders welded together or a plurality of cylinders monolithically formed.

Forms may have functions or ‘form functions’ wherein the element form may have further functions.

‘Structure’ may refer to the structure of elements which may include: hollow; solid; porous; permeable.

‘Features’ may refer to features of elements including: pores; openings; channels; textures; coatings.

Features may have functions or ‘feature functions’ wherein the features may have a particular function including: wicking; variation in surface area; hydrophilic; permeable; hygroscopic.

‘Compositions’ may refer to the way in which materials; forms; structures; features; and/or the functions of each respectively are composed which may include: layers; composites; variation in size; variations in shape; assortments and/or groupings of the aforementioned.

Compositions may have functions or ‘composition functions’ wherein the compositions may have a function including: thermally conductive; thermally insulating; electrically conductive; electrically insulating; hygroscopic; hydrophilic; hydrophobic; wicking; electrostatic; magnetic; electromagnetic; antimicrobial; deodorising; oxidising; soluble; deformable; elastic; specified coefficients of friction; resonant; tunable.

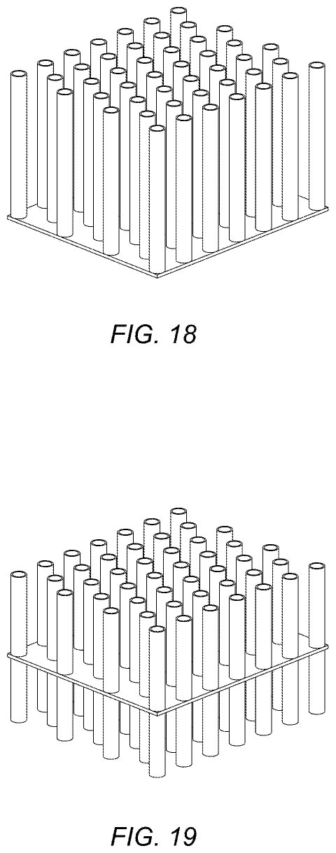

‘Arrangements’ and/or ‘Connections’ may refer to the ways in which elements are connected, arranged, and/or positioned including: detached; apart; connected part way (FIG. 19); at one end (FIG. 18); by a base; to a base; projecting from. Examples of connections may include: monolithic connections (FIG. 16); fasteners; bonds; welds; adhesives. Elements may be connected or arranged on various surfaces including: crossmembers; housing; frames; walls; bases.

Arrangements and/or connections may also comprise materials; forms; structures; features; compositions; and the functions of each respectively; for example metallic prongs may be connected to a metallic base; metallic prongs may be connected to a perforated crossmember; a grate-like structure wherein connections between cylinders are perforated.

In some embodiments the invention is a filament bracing and manipulating apparatus including: elements; a fluid movement means; a heating means; a desiccating means; a vacuum means; a mechanical movement means; a housing; input means; output means.

‘Heating means’ may refer to a means of applying and/or generating heat. Means of generating and/or applying heat may include: radiant heaters; induction heaters; magnetrons; transducers; exothermic reactions; induction; convection; radiation; chemical; mechanical. This may include plumbing and/or vessels that may hold or communicate fluids. Such fluids may be warm and may provide heat. Means to absorb and release energy as heat may include: phase changing materials or receiving surfaces which may absorb radiant energy and release heat by conductive means.

‘Fluid movement means’ may refer to a means to move ‘fluid’, or a means to generate a movement of fluid. In some embodiments the fluid may be air and referred to as an ‘air movement means’ or a means to move air. Fluids may be substances which can flow including: liquids; gases; granules; powders; and flowable compositions. Means of moving fluids may include: convection; fans; turbines; jets; blowers; pumps; pneumatics transducers; acoustic; electric; electrostatic; pressure differentials; concentrations differences; electromagnetic; magnetic. In some embodiments the fluid movement means may be a fan to move air. In some embodiments the fluid movement means may be a pump to move water. In some embodiments the fluid movement means may be an agitator to move powders or granules.

‘Desiccating means’ may refer to means of partial or complete ‘collection’ and/or ‘removal’ of ‘substances’. Collection may include: collect; capture; retain; retrieve. Removal may include: removal; expulsion; ejection; destruction; conversion. Desiccating means may include: sonic vaporisation; laser vaporisation; magnetic influences; heating means; condensing; chemical means.

‘Substance’ may refer to the substance which is desired to be collected or removed. In some embodiments a substance may be water or water vapour. In such embodiments the water vapour may be collected by condensing surfaces and expelled by pump. In other embodiments the water or water vapour may contact a desiccator wherein it is converted by electrolysis into its constituent gases thereby removing water. In other embodiments, water may be captured or collected by capillary action and may optionally be removed.

‘Vacuum means’ may refer to means of producing a reduction in atmospheric pressure within a ‘volume’. A volume may be a partially or completely sealed vessel including: housings; cases; containers; bags; chambers; covers. The means of reducing atmospheric pressure may include: pumps, including: rotary vane; venturi; piston; diaphragm; liquid ring; fans; turbine; blowers; jets; changes in temperature.

‘Mechanical movement means’ may refer to a means to generate or apply a ‘mechanical movement’. Mechanical movements may include: shaking; vibrating; agitating; oscillating. The mean for generating or applying may include: magnetic; electromagnetic; electric; acoustic; thermal; electrostatic. In some embodiments a vibration movement may be generated by means of an electric motor coupled to an eccentrically balanced mass; a transducer providing a reciprocating movement.

‘Housing’ may refer to features which may include: housings; enclosures; containers; volumes; frames. Housings may be partial or complete, for example: a partially sealed enclosure; an open frame; a complete or fully sealed container; a closed volume. Housing may for example be units such as housing units. Housing units may be: modular; collapsible; attachable; detachable.

Housings may include being: separate from other components of the invention; connected to other components of the invention; attachable to other components of the invention; detachable from other components of the invention; part of other components of the invention.

Housings may include the: materials of the elements; forms of the elements; structures of the elements; features of the elements; compositions of the elements; arrangements of the elements; connections of the elements.

In some embodiments the housing may be a frame which forms a structural member of the apparatus. In some embodiments the housing may be a detachable cover. In some embodiments the housing may be a sealed enclosure. In some embodiments, housings may connect with other housings to connect parts such as the elements to a heating means.

‘Input means’ and ‘output means’ may refer to means of inputting and/or outputting, including: receiving; collecting; sending; displaying; interpreting. Inputs may include: buttons; keys; sensors. Outputs may include: auditory; visual; haptic; tactile; colour changing materials; sounds; vibrations; lighting displays; indicators. Uses for inputs and outputs may include: safety; status; instructional means. In some embodiments sensors such as hygrometer and thermocouples may collect readings to control operating temperature and air vapour levels and communicate this via a display or indicator. For the purposes of safety and/or security purposes, in some embodiments, sensors may detect faults and/or unsafe operation.

In some embodiments the invention is a system which may include an apparatus of the invention and further include a ‘blow dryer’ (10). A blow dryer may refer to a hair dryer (10). Blow dryers typically include an air movement means such as a fan and may also include a means to generate heat such as heating elements. In such systems the apparatus of any one of the embodiments and/or examples may, with the inclusion of a blow dryer, make use of the heating and/or air movement means of a blow dryer.

In some embodiments the system of the previous embodiment may further comprise inputs and output; power control devices. In some embodiments, inputs may be sensors for temperature and humidity which may be used to determine if the power control device should disconnect power to the blow dryer.

In some embodiments the invention is a system comprising one or more filament bracing apparatus comprising a plurality of elements.

In some embodiments the invention is a method, comprising the steps of providing a filament bracing and manipulating apparatus; and at least partially brace filaments with said apparatus.

In some embodiments the invention is a method comprising the steps of providing a filament bracing and manipulating apparatus; and at least partially manipulating filaments with the apparatus.

In some embodiments the invention is a method comprising the steps of providing a filament bracing and manipulating apparatus; and at least partially contacting filaments to the apparatus.

In some embodiments the method of any one of the previous embodiments may be a means for: drying filaments; cleaning filaments; protecting filaments; coupling; collection of substances; coating filaments; transfer of energy; catalysis; grinding; mixing; electrolysis; hydrolysis.

### EXAMPLES

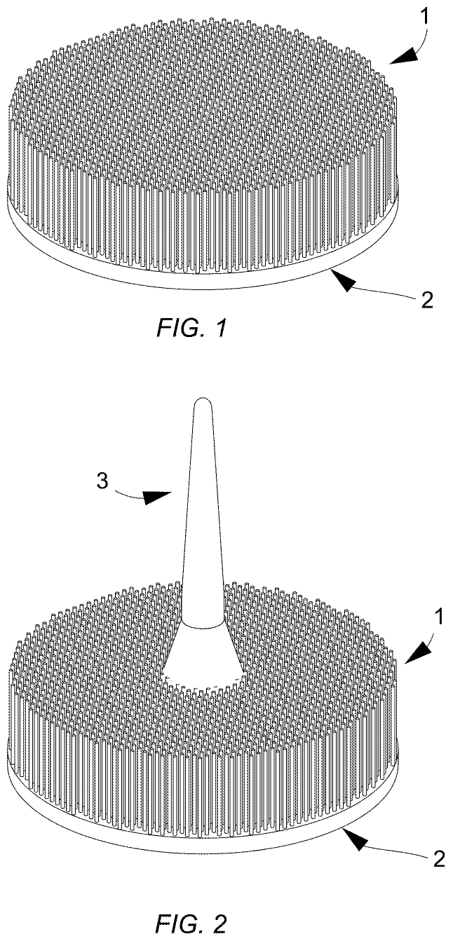

In a first example the invention is a filament bracing and manipulating apparatus comprising a plurality of elements (FIG. 1).

In a second example, according to the first example the elements being prongs (1) are connected to and projecting from a base being a crossmember (2).

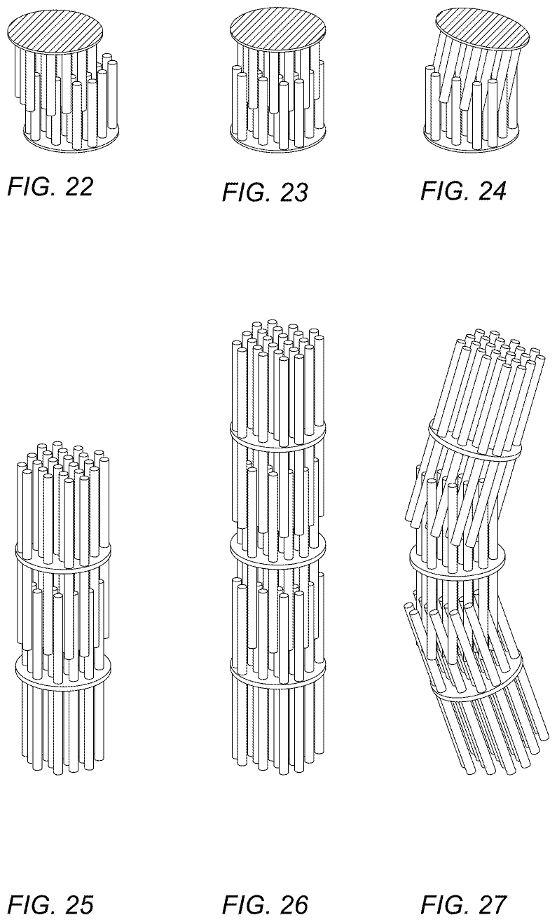

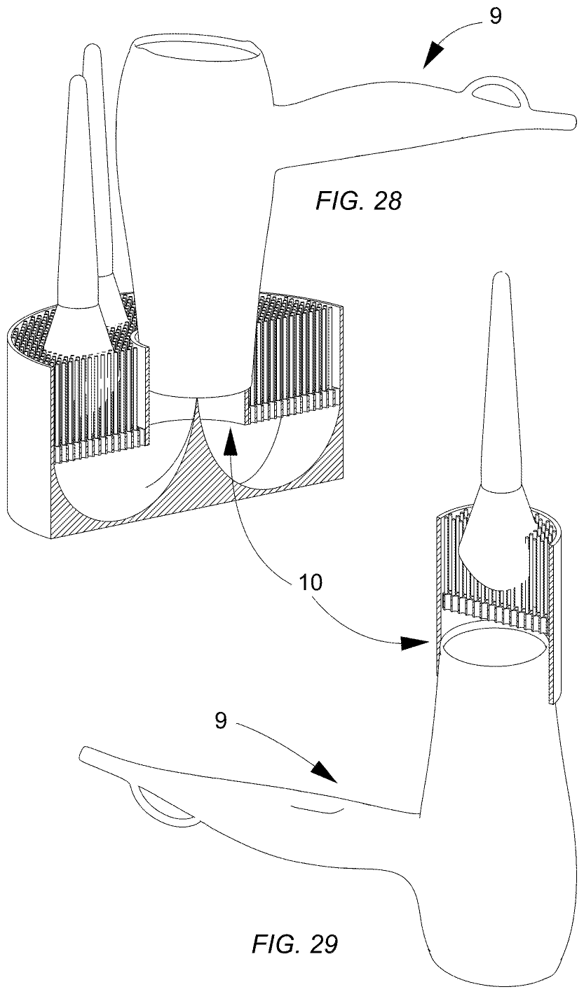

In a third example the apparatus of the second example may be connected by its crossmember to a drive shaft wherein the prongs project away from the drive shaft and base. In such an example a second drive shaft having projecting elements being filaments may contact the prongs of the apparatus such that they mesh (FIG. 23) allowing the transfer of rotational force from one drive shaft to the other. The advantage of the apparatus in such examples is the ability to couple the drive shafts with a wide variability of alignment (FIG. 22). Advantages being that alignment of the coupling is not as critical to the operation, as such it may act as a universal joint (FIG. 24). The distribution of load may be over many prongs and filaments which may help reduce stress. In examples where the prongs and filaments are of a flexible nature it may be a further advantage by dampening acceleration forces to further reduce stress.

In a fourth example, according to the third example the crossmember (FIG. 12) and/or prongs (FIG. 11) of the apparatus may be permeable to allow the flow of substances through the crossmember and/or prongs. In such an example the permeability may allow the flow of coolants, air, or lubricants into the coupling area. The advantages may include: improved application of such substances to improve cooling and reduced friction and wear.

In a fifth example, according to the first example a plurality of elements being filaments may be connected at the middle of their length such that the filaments project either side of the connection (FIG. 25). In such an example the filaments of one apparatus may contact the elements being filaments of at least one other apparatus such that they form a linear chain (FIG. 26). In such an example each apparatus may have a freely movable connection to the other apparatus (FIG. 27). The example may further include a housing being a flexible sealed covering such that air may be evacuated from the cover to apply a constricting force around the filaments. In such an example the constriction forces the filaments together and locks them in position. The advantages of such an example may be the ability to position each apparatus in the chain (FIG. 27) before evacuating the cover and locking the positioning. A further advantage is the filaments may provide structure to the apparatus as a whole such that the covering may not be required to provide substantial structure. The high surface area in contact with each apparatus in the chain may provide a stronger structure when constricted.

In a sixth example, according to the fifth example the elements of the apparatus may have features such as texturing which may increase surface area and friction. In such an example the texture may be teeth or perpendicular ridges along the elements. In such an example the elements may freely move when not constricted but when constriction is applied the elements may be forced together such that the teeth may interlock in the position they were placed. The advantage of such an example may be increased rigidity of the connections between elements of each apparatus.

In a seventh example according to any one of examples five or six the cover may instead house a dilatant fluid. The viscosity change of the fluid may cause a stiffening effect across the filaments of the apparatus such that a chain of apparatus may appear to stiffen under stress. In such examples, the perpendicular teeth of the sixth example may advantageously increase the surface area for these forces to apply across.

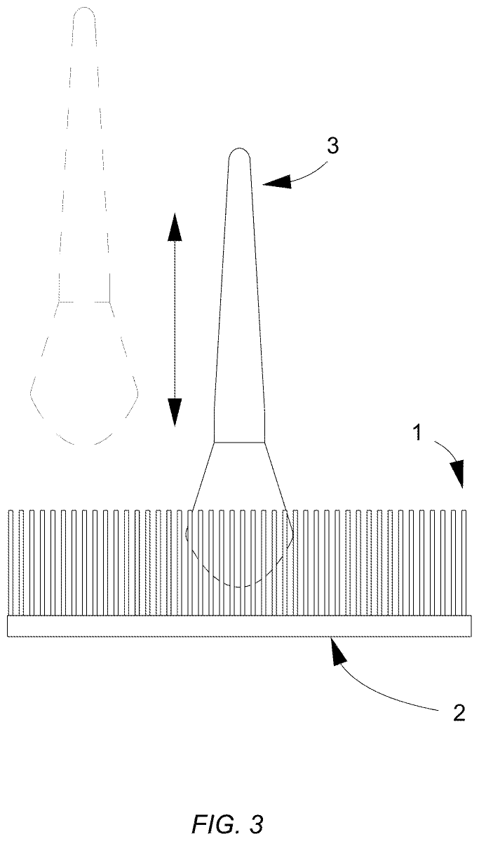

In an eighth example the apparatus of the second example wherein a brush (3) comprising filaments being bristles may be contacted (FIG. 3) such that the prongs of the apparatus (1) mesh with the bristles of the brush (3). The bristles of the brush being braced by the prongs of the apparatus advantageously provides protection to the filaments of the brush. In such examples the apparatus may function to protect and preserve the filaments of the brush for applications such as: the preservation of antiquities in conservation where the brush may need to be stored or transported; the storage and transport of cosmetic brushes. The bracing of filaments when drying such that they remain in a particular form during drying. Supporting the brush during drying such that it may not require further a method of holding (FIG. 2).

In a ninth example according to the eighth example wherein the base (12) has perforations (11)) such that air may flow through the base. In such an example air may flow toward the filaments of the brush and along channels between the prongs and the filaments. The advantage of such an example is the increased air circulation within the brush filaments and improving drying efficiency when moisture may be present. Further to such examples the prongs may also be hollow and have perforation (FIG. 11) such that air may flow through the base and through the prongs and exit through the perforations in the prongs. The advantages of such an example may include: increased circulation of air within the bristles of the brush; increased efficiency of the delivery of the air; increased drying efficiency when moisture may be present.

In a tenth example, the ninth example further including an air movement means such as a fan (6). Wherein the fan forces air through the base and prongs toward the bristles of the brush. The advantage of such an example may be that a greater flow of air may reach and penetrate deeper into the bristles of the brush to further increase drying efficiency. A further advantage is the bracing of the bristles by the prongs which helps to restrict the displacement of filaments allowing for much greater airflow rates without substantial displacement or damage of the bristles.

In an eleventh example according to example eight wherein the prongs and base are of thermally conductive material such as metal and further including a heat applicator. In such an example the heat applicator may be a heating element contacting the base. In such an example the heat may conduct from the heater element to the base and to the prongs which may conduct or radiate the heat to the filaments of the brush. The advantages of such an example may include: an increase in drying efficiency by more direct application of heat to vaporise water; direct application of heat with a greater surface area; increased drying efficiency at lower temperatures which may be desirable to prevent damage to bristles. A further advantage may be the bracing of the filaments during heat application to prevent distortion which may cause filaments to retain undesirable forms.

In a twelfth example, according to example ten further including a heat applicator such as a heating element (7). In such an example the fan (6) may pass air over the heating element (7) to warm the air before it passes through the perforated base and prongs (8) such that the air being delivered within and around the brush bristles. Advantages may include: further improvements in drying efficiency by evaporation of moisture deep within the bristles.

In a thirteenth example according to any one of the examples wherein there is a reference to a heat applicator. The applicator may be a vessel or plumbing which may contain a fluid such as water. The lining of the vessel or plumbing may be in contact with the prongs. In such examples hot or warm water may be added and provide the means of applying heat through conduction.

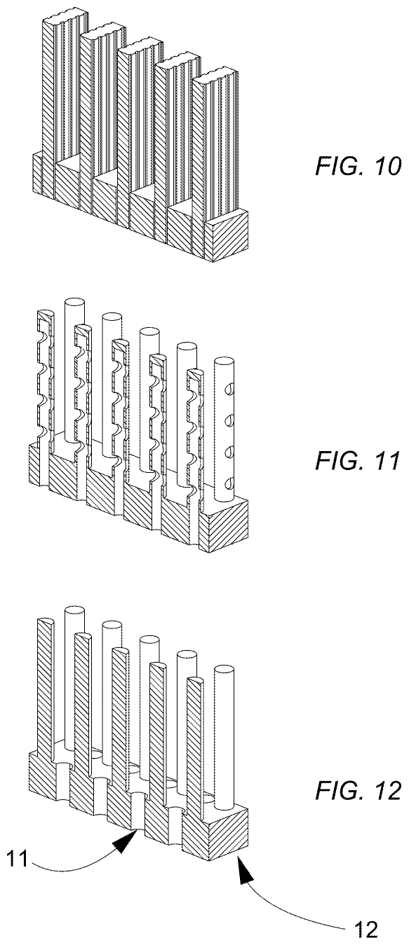

In a fourteenth example according to any one of the previous examples the prongs of such examples may have features such as channels FIG. 10) which may function to wick substances such as moisture through capillary action. The advantages of such an example may include: greater efficiency of moisture removal by way of a greater surface area and distribution of wicking channels.

In a fifteenth example the channels (FIG. 10) of example fourteen may instead function as air passages. In such an example much like the hollow and porous (FIG. 11) aspects of previous examples, the channels may allow a passage of air between the bristles of a brush. The advantage of such an example may include: an increase in drying efficiency.

In a sixteenth example according to any one of the previous examples wherein moisture may be present the following example further includes a means of desiccating. In some examples desiccating may be by way of electrolysis of water wherein the prongs may act as electrodes. In other examples the prongs may be of hygroscopic materials to absorb moisture and dry the filaments. The advantages of these examples may include: a higher surface area in contact with the moisture increasing the drying efficiency.

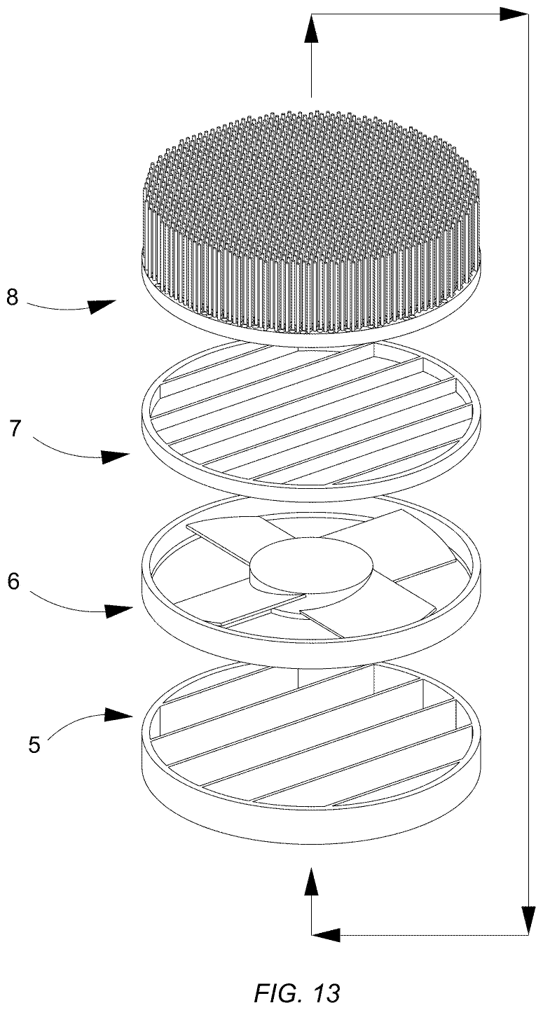

In a seventeenth example according to any one of the previous examples wherein the desiccator is a condensing surface (5); the air movement is by fan (6); a heat applicator being a heating element (7); and further including a housing being an enclosed volume designed in such a way as to recirculate air. In such an example air moved by the fan (6) may pass over the heating element (7) to heat the air which then passes through the hollows and perforations of the base and/or prongs (8). The warm air may circulate amongst the bristles of the brush evaporating moisture. Moisture in the air may then condense on the cooler condensing surfaces (5) as the air is recirculated back through the cycle (FIG. 13). Condensed moisture may then be collected and ejected. The advantages of such an example may include: utilising dryer warmer air which may increase the drying efficiency; containing the water vapour and reducing heat loss through the cycle.

In an eighteenth example according to any one of the previous examples further including a mechanical movement means being a transducer which may apply a vibration to the prongs. In such an example the vibration may assist the removal of excess water which may shake off and drip through a permeable base to be collected. Further to this example the prongs may then apply heat to further remove moisture.

In a nineteenth example according to example eighteen the mechanical movement means may be a motor which applies a rotation to the base and the prongs. In such an example the apparatus may further include a housing. The centrifugal force as the prongs and brush rotate may cause water to be ejected outward and captured by the housing.

The advantages of examples eighteen and nineteen may include: an increase in drying efficiency as excess water may be more efficiently removed by mechanical means followed by evaporation.

In a twentieth example the fluid movement means of any one of the previous examples such as an air movement means may move air through the base and/or prongs away from the filaments. In such an example the substances may be drawn away from the filaments. Substances such as water may be drawn from within the bristles through the prongs. In other such examples warm air may be drawn toward and through the bristles as compared to examples describing warm air being moved from inside to out.

In a twenty-first example according to the twentieth example the substance being drawn from the bristles may be particulates. In such an example, brush filaments may contain particulates that are desirable to collect.

In a twenty-second example the apparatus of any one of the previous examples may further include: element materials which may collect substances; structures which may collect substances; features which may collect substances. In one such example the apparatus of example two wherein the prongs may be electrostatic and may provide an attractive force to collect charged particles from the bristles of a brush.

The advantages of examples twenty one and twenty two may include: the containment of the particulates to be collected such that it minimises waste or loss.

In a twenty-third example according to any one of the previous examples the apparatus may further include a means of cleaning or sanitising such that the apparatus may clean bristles by agitation of the prongs before removal of any substances. It may further apply a means of sanitation to the filaments for example: irradiating; heat treating; contact with antimicrobial materials.

In a twenty-fourth example the apparatus of any one of the previous examples may be part of a system for example a system comprising the apparatus and a brush with bristles. In such an example the brush may be used for swabbing and collection of substances. The apparatus may be configured with attributes that allow efficient collection and retrieval of substances from the bristles.

In a twenty-fifth example the apparatus of any one of the previous examples may be part of a system further including: a second apparatus of any one of the previous examples. The second apparatus may contact the first apparatus as a coupling system (FIG. 23). In such an example the system may be an advantageous way of coupling for uses including: energy transfer; moveable joints; joining; coupling; linking.

In a twenty-sixth example according to any one of the previous examples the apparatus of the invention may be: collapsible; deconstructable; modular. For reasons including being easier to: store; clean; transport the apparatus.

In a twenty-seventh example the apparatus of any one of the previous examples wherein it may require a source of energy may obtain this by any known means.

In a twenty-eighth example the apparatus of any one of the previous examples may further include: an inlet (10) configured to receive a blow dryer (9).

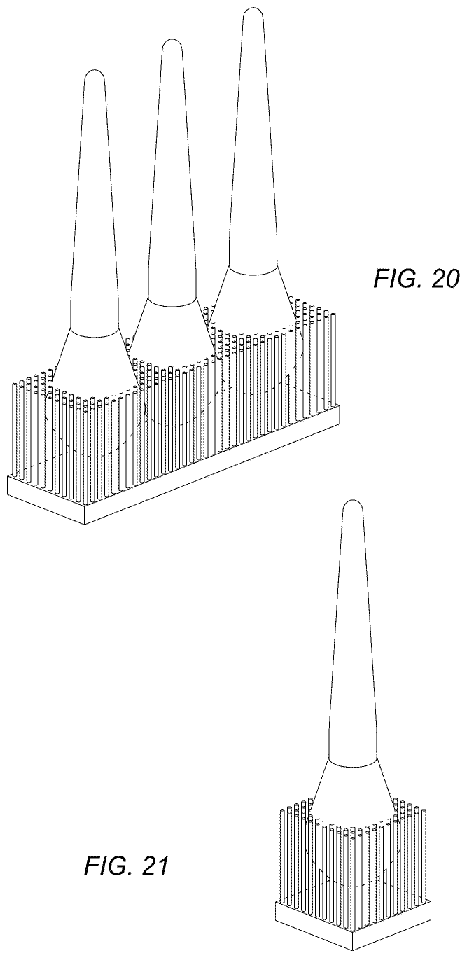

In a twenty-ninth example the apparatus, systems, or methods of any one of the previous examples may have variations including: configured for one or more brushes (FIG. 21, FIG. 20); configured for specific brushes or filaments (E.g. bristles); configurable and/or adjustable; serviceable.

In a thirtieth example the apparatus of any one of the previous embodiments wherein the apparatus includes a fluid movement means (including by convection). Fluid (E.g. air) may move any any suitable way including: perpendicular to elements; parallel to elements; turbulently; laminarly; orbitally; combination of the aforementioned.

In a thirty-first example the apparatus of any one of the previous examples may further include a means of directing the flow of fluids including: focusing; blocking; guiding; modulating. Flow may be selectably or variably adjustable; for example a flow of air may be selectably partitioned such that air may be directed away or blocked from some areas of the element and directed toward or focused on other areas.

In a thirty-second example the apparatus, systems, or methods of any one of the previous examples may contact filaments in any suitable orientation including: parallel to elements; perpendicular to elements.

In a thirty-third example the apparatus of any one of the previous examples may be shaped in any suitable way inducing: concave base; convex base; staggered base; combinations of shapes.

It will be appreciated and understood to those skilled in the art that the present aspects, examples, and embodiments of the invention are not representative of the entirety of envisioned aspects, examples, and embodiments. It will therefore be understood that changes, modifications and combinations; of aspects, examples, and embodiments; and their parts will be included without departing from the spirit and scope of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A filament bracing and manipulating apparatus, comprising at least:
a base; and
a plurality of elements;
wherein:
each of the plurality of elements extend from the base such that a longitudinal axis of each of the plurality of elements are substantially perpendicular to a top surface of the base;
at least a portion of the plurality of elements engages with filaments of a component;
the plurality of elements is structured and arranged to brace the filaments, whereby the engagement of the at least the portion of the plurality of elements with the filaments restricts displacement of the filaments and prevents distortion of the filaments caused by at least one of: heat and forced air; and
at least a portion of the filaments are substantially parallel to the plurality of elements when the at least the portion of the plurality of elements are engaged with the filaments.

20. The apparatus of claim 19, wherein:
the apparatus further comprises a means to move fluid; and
the means to move fluid comprises at least one of: convection; a fan; a turbine; a jet; a blower; a pump; electrically induced fluid movement; pressure differential induced fluid movement; electromagnetically induced fluid movement; and magnetically induced fluid movement.

21. The apparatus of claim 20, wherein:
the fluid is air;
the means to move air comprises the fan; and
the fan is positioned such that air is blown from the base towards the filaments engaged with the at least the portion of the plurality of elements.

22. The apparatus of claim 21, wherein the fan is positioned below the base such that air is blown upwards onto the filaments engaged with the at least the portion of the plurality of elements.

23. The apparatus of claim 21, wherein:
at least one of: the base and at least some of the plurality of elements comprise a plurality of perforations through which the air flows;
the fan is positioned such that air is blown from the base, through the plurality of perforations of at least one of: the base and the at least some of the plurality of elements, and onto the filaments engaged with the at least the portion of the plurality of elements.

24. The apparatus of claim 23, wherein the fan is positioned below the base such that the air is blown upwards through the plurality of perforations of at least one of: the base and the at least some of the plurality of elements and onto the filaments engaged with the at least the portion of the plurality of elements.

25. The apparatus of claim 21, wherein:
the apparatus further comprises a heating means; and
the heating means heats the air such that heated air is blown onto the filaments engaged with the at least the portion of the plurality of elements.

26. The apparatus of claim 19, wherein:
the apparatus further comprises a heating means for heating the plurality of elements;
heat is transferred from the plurality of elements to the filaments engaged with the at least the portion of the plurality of elements; and
wherein the heating means comprises at least one of: induction; convection; conduction; and radiation.

27. The apparatus of claim 19, wherein:
the apparatus further comprises a port configured to receive at least a portion of a hairdryer; and
the hairdryer moves air.

28. The apparatus of claim 27, wherein:
at least one of: the base and at least some of the plurality of elements comprise a plurality of perforations through which the air flows; and
the port configured to receive the at least the portion of the hairdryer is positioned such that air is blown from the base towards the plurality of perforations of at least one of: the base and the at least some of the plurality of elements and onto the filaments engaged with the at least the portion of the plurality of elements.

29. The apparatus of claim 19, wherein:
the apparatus further comprises a mechanical movement means for shaking, agitating, oscillating, or vibrating the plurality of elements; and
the mechanical movement means comprises at least one of: electromagnetically induced movement; electrically induced movement; acoustically induced movement; and
electrostatically induced movement.

30. The apparatus of claim 19, wherein:
the apparatus further comprises a sanitizing means for sanitizing the filaments; and
the sanitizing means comprises at least one of: irradiation; heat induced sanitization; and
contact with antimicrobial materials.

31. The apparatus of claim 19, wherein:
the apparatus further comprises a means for collecting or removing substances from the filaments; and
the means for collecting or removing substances comprises at least one of: sonic vaporisation; heating means; condensing means; chemical means; capillary action; mechanical means; and electrolysis of water wherein the elements act as electrodes.

32. The apparatus of claim 19, wherein the apparatus further comprises:
a second set of a plurality of elements separate from the first set of the plurality of elements; and
a blocking component configured to block fluid from flowing towards the first set of the plurality of elements or the second set of the plurality of elements such that fluid is forced to only flow towards the unblocked set of the plurality of elements.

33. The apparatus of claim 19, wherein:
the component is a brush;
each of the plurality of elements comprises a prong; and
at least one of: each of the plurality of elements and the base are fabricated of thermally conductive material.

34. The apparatus of claim 19, wherein at least two of:
the component is a brush;
the apparatus further comprises a housing within which the plurality of elements are housed;
the apparatus further comprises a sealable housing within which the component and the plurality of elements are housed;
the apparatus comprises input and output means for receiving or relaying at least one of: safety, status, and instructional information;
the input means comprises at least one of: a hygrometer and a thermocouple for collecting readings to control operating temperature and air vapour levels;
the output means displays or indicates at least one of: the temperature or air vapour levels;
the input means comprises a sensor for detecting apparatus faults or unsafe operation of the apparatus; and
the output means displays or indicates when an apparatus fault or an unsafe operation is detected.

35. A method for bracing and manipulating filaments, comprising:
engaging at least a portion of a plurality of elements with filaments of a component to braces the filaments, thereby restricting displacement of the filaments and preventing distortion of the filaments;
wherein:
each of the plurality of elements extend from a base such that a longitudinal axis of each of the plurality of elements are substantially perpendicular to a top surface of the base;
the filaments are substantially parallel to the plurality of elements when the at least the portion of the plurality of elements are engaged with the filaments; and
the apparatus comprises a fan to move air positioned below the base such that air is blown from the base towards the filaments engaged with the at least the portion of the plurality of elements.

36. The method of claim 35, wherein:
at least one of: the base and at least some of the plurality of elements comprise a plurality of perforations through which the air flows;
the fan is positioned below the base such that the air is blown through the plurality of perforations of at least one of: the base and the at least some of the plurality of elements and onto the filaments engaged with the at least the portion of the plurality of elements;
the apparatus further comprises a heating means; and
the heating means heats the air such that heated air is blown through the plurality of perforations of at least one of: the base and the at least some of the plurality of elements and onto the filaments engaged with the at least the portion of the plurality of elements.

37. The method of claim 35, wherein:
the apparatus further comprises a heating means for heating the plurality of elements;
heat is transferred from the plurality of elements to the filaments engaged with the at least the portion of the plurality of elements; and
wherein the heating means comprises at least one of: induction; convection; conduction; and radiation.

38. The method of claim 35, wherein:
the apparatus further comprises a mechanical movement means for shaking, agitating, oscillating, or vibrating the plurality of elements; and
the mechanical movement means comprises at least one of: electromagnetically induced movement; electrically induced movement; acoustically induced movement; and
electrostatically induced movement.
